(19) United States
(12) Patent Application Publication
(10) Pub. No.: US 2005/0198329 A1
(43) Pub. Date: Sep. 8, 2005

(54) Relational database and a method of enabling access to a data structure stored therein

(76) Inventors: Mark W. Byrd, Downingtown, PA (US); Joseph H. Holland, Barrington, IL (US)

Correspondence Address: RATNERPRESTIA, P O BOX 980, VALLEY FORGE, PA, 19482-0980, US

(21) Appl. No.: 10/969,656

(22) Filed: Oct. 20, 2004

Related U.S. Application Data
(63) Continuation-in-part of application No. 10/762,879, filed on Jan. 22, 2004.

(51) Int. Cl. G06F 15/16

(52) U.S. Cl. 709/229; 709/217

(57) ABSTRACT

A relational database structured according to a relational data model for access by users from an application program is provided, and includes a relational table including at least a first set of relational data stored therein, and at least one linked text field having a second set of relational data stored therein, the relational data of the first set stored in the relational table being in a one-to-many correspondence with relational data of the second set stored in the at least one linked text field.

### CROSS REFERENCE TO RELATED APPLICATIONS

This present application is a continuation-in-part of pending U.S. patent application Ser. No. 10/762,879, filed on Jan. 22, 2004, the contents of which are incorporated by reference herein.

### FIELD OF THE INVENTION

This invention relates to a relational database and a method of enabling access to a data structure stored in the relational database, and more particularly, to using e-mail addresses of users to enable access to relational data stored in the relational database as linked text files.

### BACKGROUND OF THE INVENTION

In the preparation of a single electronic document (e.g., a spreadsheet), multiple users often collaborate, for example, to produce a composite budget and/or a composite business plan for an organization or in certain industrial environments, multiple individuals may be responsible for entering or maintaining data in varying sections of the single electronic document.

Typically, such an electronic document is distributed to the multiple users. Each of the users updates the section of the document for which they have responsibility. After each of the users performs their update, all of the updates must be consolidated into a single version of the electronic document. The task of consolidating the updates is often tedious, time-consuming, and error-prone.

An alternative approach is to distribute a single electronic document to the users, one user at a time. In such a scenario, after one user completes their update, the updated electronic document is provided to another user, and so on, until each of the users has been able to update their respective section of the document. This approach is undesirably time-consuming, as each of the users waits for their turn to access the electronic document. Further, because each user updates their respective portion of the electronic document at a different time, the finished document may not reflect the present status of the data included in the document.

### SUMMARY OF THE INVENTION

According to one exemplary embodiment of the invention, a relational database structured according to a relational data model for access by an application program that executed on a data processing system is provided. The relational database includes a relational table including at least a first set of relational data stored therein, and at least one linked text field having a second set of relational is data stored therein, the relational data of the first set stored in the relational table being in a one-to-many correspondence with relational data of the second set stored in the at least one linked text field.

According to another exemplary embodiment of the invention, a method of enabling access to a data structure is provided. The method includes designating e-mail addresses of users with respective sections of the data structure. The method also includes enabling access to the respective sections to users corresponding to the designated e-mail addresses.

### BRIEF DESCRIPTION OF THE DRAWINGS

Exemplary embodiments of the invention will be described with reference to the drawings, of which:

FIG. 1 is an illustration of a portion of a data structure in accordance with an exemplary embodiment of the present invention;

FIG. 2 is an illustration of another portion of the data structure illustrated in FIG. 1;

FIG. 3 is another illustration of a portion of a data structure in accordance with another exemplary embodiment of the present invention;

FIGS. 4 is a flow diagram illustrating a method of enabling access to a data structure in accordance with an exemplary embodiment of the present invention;

FIG. 5 is another illustration of a portion of a data structure in accordance with another exemplary embodiment of the present invention;

15 FIG. 6 is yet another illustration of a portion of a data structure in accordance with another exemplary embodiment of the present invention;

FIG. 7 is a flow diagram illustrating another method of enabling access to a data structure in accordance with another exemplary embodiment of the present invention;

FIG. 8 is a block diagram illustrating association of a data structure including e-mail addresses with other data structures in accordance with another exemplary embodiment of the present invention;

FIG. 9 is a flow diagram illustrating another method of enabling access to a data structure in accordance with another exemplary embodiment of the present invention;

FIG. 10 is a block diagram illustrating a relational database in accordance with another embodiment of the present invention; and

FIG. 11 is a block diagram illustrating another relational database in accordance with another embodiment of the present invention.

### DETAILED DESCRIPTION OF THE INVENTION

Preferred features of embodiments of this invention will now be described with reference to the figures. It will be appreciated that the spirit and scope of the invention is not limited to the embodiments selected for illustration. It is contemplated that any of the configurations described hereafter can be modified within the scope of this invention.

Referring to the Figures generally, the present invention relates to associating e-mail addresses of users with sections of a data structure (e.g., a spreadsheet) Through this association, each of the users is able to access the sections of the data structure (e.g., data cells in the spreadsheet) associated with his/her e-mail address.

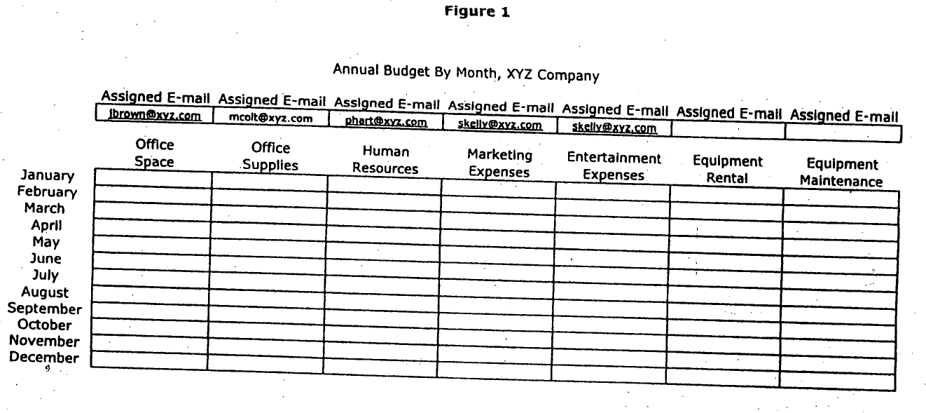

Referring now to FIG. 1, a spreadsheet is provided which summarizes the annual budget of XYZ Company. Each of a number of budget areas of the company (i.e., Office Space, Office Supplies, Human Resources, Marketing Expenses, Entertainment Expenses, Equipment Rental, and Equipment Maintenance) are assigned a column in the spreadsheet. Each of these budget areas includes a data cell for each month of the year. For example, the monthly budget of the budget area is intended to be entered into this data cell. Above each budget area column is an “Assigned E-mail” data cell. By entering an e-mail address of a user into the “Assigned E-mail” data cell, the user corresponding to the e-mail address is given access to the data cells in the budget area column. As such, John Brown (i.e., the user corresponding to the e-mail address jbrown@xyz.com) has been given access rights to the data cells in the “Office Space” budget area column. Likewise Mike Colt has been given access rights to the data cells in the “Office Supplies” budget area column, Paul Hart has been given access rights to the data cells in the “Human Resources” budget area column, and Sam Kelly has been given access rights to the data cells in the “Marketing Expenses” and “Entertainment Expenses” budget area columns. As indicated by the blank “Assigned E-mail” data cells, no user has been given access rights to the data cells in the “Equipment Rental” and “Equipment Maintenance” budget area columns.

In certain embodiments of the present invention, a user may only be able to view the portion of the data structure to which the user has been provided access rights to. In such an embodiment, for example, John Brown may only be able to see the data cells in the Office Space budget area column, Mike Colt may only be able to view the data cells in the Office Supplies budget area column.

As described herein, access or access rights refers to any of a broad class of data structure access rights, for example, editing access, viewing access, creation access, and any combination thereof. As such, a user may be given access to edit a section of a data structure, to view a section of a data structure, to create a section of a data structure, and any combination thereof.

According to an exemplary embodiment of the present invention, after access rights have been assigned to a user by associating the user's e-mail address with a portion of a data structure, an e-mail may be sent to the user to notify the user of the user's access rights. Such an e-mail may be configured to be automatically transmitted upon the access rights being assigned.

After being provided with access rights to a section of a data structure, the user may establish a password such that other users may not access the section of a data structure. In certain exemplary embodiments of the present invention, higher level users may retain access rights to the section of the data structure.

For example, in FIG. 1, a single user (or a group of users) may have access to the entire annual budget spreadsheet. Thus, this single user may enter e-mail addresses of other users (e.g., John Brown) into one or more of the “Assigned E-mail” data cells (e.g., the Assigned E-mail data cell corresponding to the Office Space section of the spreadsheet) in order to provide access rights to the user. In this example, John Brown has access rights to the Office Space column of cells; however, the assigning single user may also retain access rights to the Office Space column of cells.

According to an exemplary embodiment of the present invention a user may reassign all or a portion of their access rights to one or more additional users by associating the e-mail addresses of the additional users to the corresponding section of the data structure.

The data structure may be stored in any of a number of locations, for example, as a file on a personal computer or a mainframe computer. Further, the data structure may be configured in connection with a database server on a personal computer or a mainframe computer. If users access the data structure from remote locations, such access may be accomplished through any of a number of conventional connections (e.g., the Internet, other network connections, etc.). Further, in an Internet embodiment, the access connection may be facilitated through a web browser.

When connecting via a web browser, a user may be prompted for information identifying the user to restrict access from unauthorized users. For example, the identifying information may be a user ID and a password. According to the present invention, the user ID may be the e-mail address of the user, and the password is the same for all applications to which the user has been provided access.

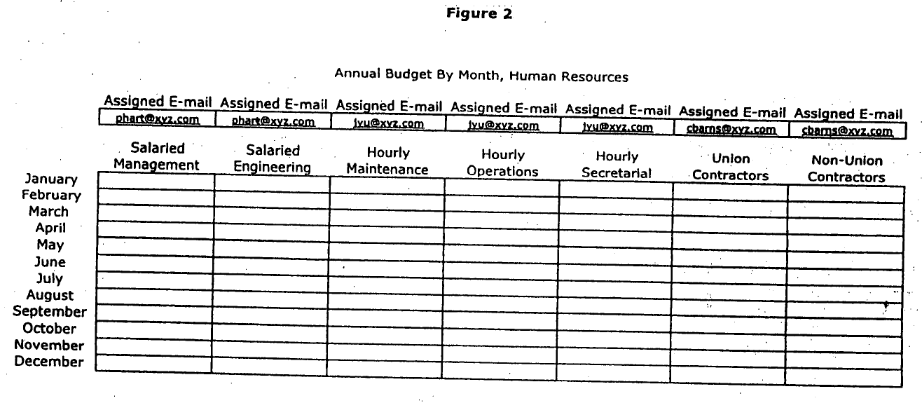

FIG. 2 is another layer of the portion of the data structure illustrated in FIG. 1. More specifically, FIG. 2 is a spreadsheet which summarizes the annual Human Resources budget of XYZ Company. FIG. 1 indicated that Paul Hart (i.e., the user corresponding to the address phart@xyz.com) has access rights to the Human Resources budget data cells. FIG. 2 is a detail of the Human Resources budget, which may be accessed, for example, by clicking on the Human Resources tag in FIG. 1. In FIG. 2, each of a number of Human Resource budget areas (i.e., Salaried Management, Salaried Engineering, Hourly Maintenance, Hourly Operations, Hourly Secretarial, Union Contractors, and Non-Union Contractors) is assigned a column in the spreadsheet. Each of these Human Resource budget areas includes a data cell for each month of the year. As in FIG. 1, above each budget area column in FIG. 2 is an “Assigned E-mail” data cell. By entering an e-mail address of a user into the “Assigned E-mail” data cell above a given budget area column, the user corresponding to the e-mail address is given access to the data cells in the budget area column. As such, Paul Hart, who was given access to the entire Human Resources budget in FIG. 1, has retained access rights to the “Salaried Management” and “Salaried Engineering” budget area columns. However, Paul Hart has assigned access rights to other areas of the Human Resources budget to other users. For example, Javier Yu has been given access rights to the “Hourly Maintenance,” “Hourly Operations,” and “Hourly Secretarial” budget area columns. Likewise, Clifford Barns has been given access rights to the “Union Contractors” and “Non-Union Contractors” budget area columns. Although Paul Hart has provided access right to certain sections of the Human Resources budget to Javier Yu and Clifford Barns, Paul Hart may also retain access rights to these areas.

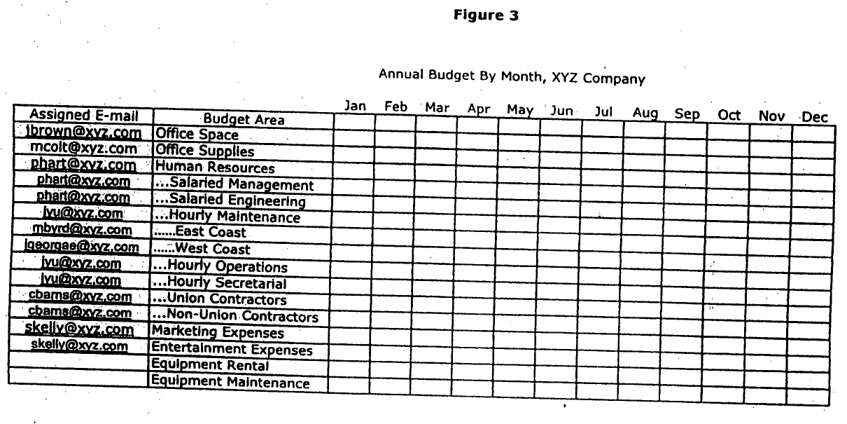

FIG. 3 is a spreadsheet summarizing the annual budget of XYZ Company including data similar to that included in FIGS. 1-2. In contrast to FIGS. 1-2 where the “Assigned E-mail” cells are above each data column, the “Assigned E-mail” cells are provided in a single column in FIG. 3. Likewise, all of the “Budget Area” cells (e.g., Office Space, Office Supplies, etc.) are provided in a single column. Each of the general budget areas from FIG. 1 are also included in FIG. 3 (Office Space, Office Supplies, Human Resources, Marketing Expenses, Entertainment Expenses, Equipment Rental, and Equipment Maintenance), and each of these general budget areas have been associated with the same e-mail addresses. As such, the users corresponding to each of these e-mail addresses has access rights with respect to the budget areas. For example, John Brown can access the data cells in the Office Space budget area row.

As opposed to having one layer of the data structure in a first spreadsheet (e.g., FIG. 1 including general budget areas including Human Resources), and another layer of the data structure in a second spreadsheet (e.g., FIG. 2 detailing the Human Resources budget), FIG. 3 includes multi-layer information. Thus, within the Human Resources budget are the Salaried Management, Salaried Engineering, Hourly Maintenance, Hourly Operations, Hourly Secretarial, Union Contractors, and Non-Union Contractors budgets. Further, within the Hourly Maintenance budget is the East Coast Budget and the West Coast budget.

In the spreadsheets included in FIGS. 1-3, a “Assigned E-mail” field is provided for each row (FIG. 3) or column (FIGS. 1-2). This field may generically be called an “assignment field” or an “assignment section” because it indicates that the user has been assigned certain access rights. Alternatively, this field may be called a “linking field” or a “linking section” because it links a row or column (e.g., a budget area) to a user through the user's e-mail address.

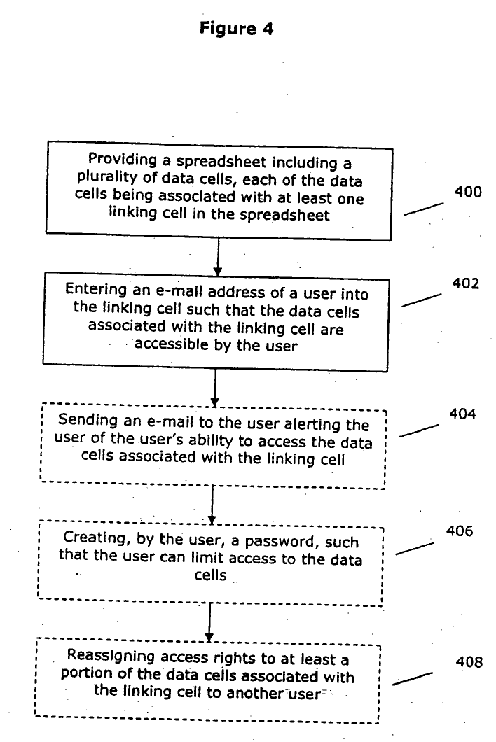

FIG. 4 is a flow diagram illustrating a method of enabling access to a data structure where the data structure is a spreadsheet. At step 400, a spreadsheet including a plurality of data cells is provided. Each of the data cells is associated with at least one linking cell in the spreadsheet. FIGS. 1-3 are examples of such a spreadsheet. At step 402, an e-mail address of a user is entered into the linking cell such that data cells associated with the linking cell are accessible by the user. For example, in FIG. 1, Paul Hart's e-mail address (phart(xyz.com) has been entered into the linking field associated with the “Human Resources” data cells. Thus, Paul Hart can access the data cells (e.g., January, February, etc.) associated with the “Human Resources” budget.

At optional step 404, an e-mail is sent to the user alerting the user of the user's ability to access the data cells associated with the linking cell. In the example described above, Paul Hart is sent an e-mail alerting him that he may access the data cells associated with the Human Resources budget. At optional step 406, the user creates a password such that the user can limit access to the data cells associated with the user's e-mail address. In the example described above, Paul Hart may create a password to limit access to the Human Resources budget data cells; however, Paul may not be able to limit access to the Human Resources budget data cells from higher level users. Such users may be, for example, users who have access to the entire budget of XYZ Company.

At optional step 408, the user reassigns access rights to at least a portion of the data cells associated with the linking cell to another user. As provided above, Paul Hart has access to the entire Human Resources budget (from the access rights given to him in FIG. 1). In FIG. 2, Paul Hart has reassigned access rights to the Hourly Maintenance, Hourly Operations, and Hourly Secretarial budgets to Javier Yu, and has reassigned access rights to the Union Contractors and Non-Union Contractors budgets to Clifford Barns. Of course, Paul Hart may also retain the ability to access these budget areas.

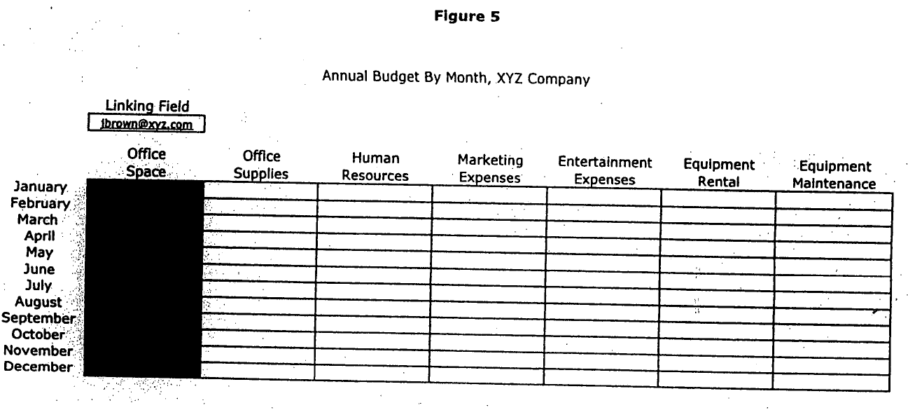

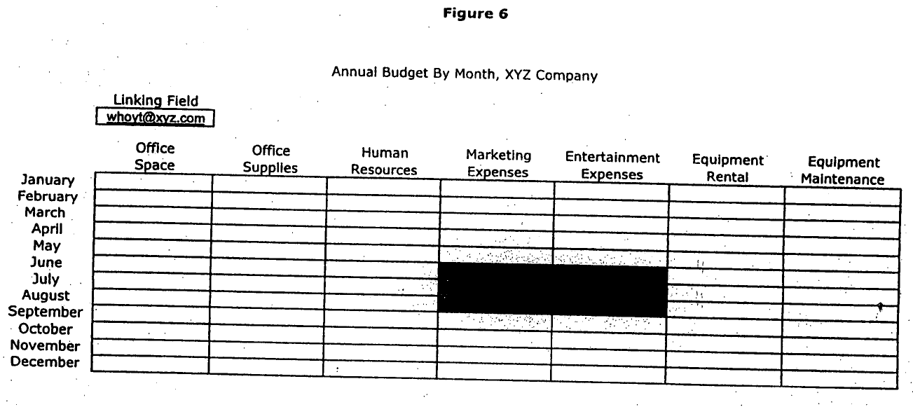

FIG. 5 is a spreadsheet that is similar to the spreadsheet illustrated in FIG. 1; however, in contrast to including a linking field for each column as in FIG. 1, a single linking field is provided in FIG. 5. In the exemplary embodiment illustrated in FIG. 5, in order to assign access rights to a portion of the data structure (i.e., data cells in the spreadsheet), the data cells are highlighted (e.g., using a mouse), and then an e-mail address is entered into the linking field. Through this operation, access rights to the highlighted data cells are provided to the user corresponding to the e-mail address entered into the single linking field. In FIG. 5, the Office Space column of data cells have been highlighted (i.e., selected). Further, John Brown's e-mail address (i.e., jbrown@xyz.com) has been entered into the linking field associated with the spreadsheet. Thus, John Brown has been given access rights to the Office Space data cells. Naturally, this operation may be continued for multiple access right assignments.

In FIGS. 1-3 and 5, access rights have been provided by entire columns or rows; however, access rights can be provided to any combination of data cells. For example, in FIG. 6 the Marketing and Entertainment Expense data cells have been highlighted for the months of June through August. Waite Hoyt's e-mail address (whoyt@xyz.com) has been entered into the linking field, and as such, Waite Hoyt has been given access rights to the Marketing and Entertainment Expense data cells for the months of June through August.

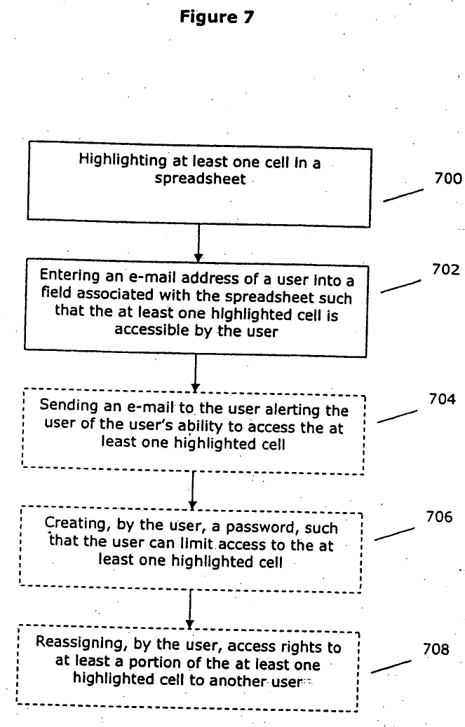

FIG. 7 is a flow diagram illustrating a method of enabling access to a data structure where the data structure is a spreadsheet corresponding to the exemplary spreadsheets illustrated in FIGS. 5-6. At step 700, at least one data cell in a spreadsheet is highlighted. For example, in FIG. 5 the data cells corresponding to the Office Space budget have been highlighted. At step 702, an e-mail address of a user is entered into the linking cell such that the highlighted data cells are accessible by the user. For example, in FIG. 5, John Brown's e-mail address (jbrown@xyz.com) has been entered into the linking field when the “Office Space” data cells have been highlighted/selected. Thus, John Brown can access the is data cells (e.g., January, February etc.) associated with the “Office Space” budget.

At optional step 704, an e-mail is sent to the user alerting the user of the user's ability to access the at least one highlighted data cell. In the example described above, John Brown is sent an e-mail alerting him that he may access the data cells associated with the Office Space budget. At optional step 706, the user creates a password such that the user can limit access to the at least one highlighted data cell. In the example described above, John Brown creates a password to limit access to the Office Space budget data cells; however, John may not be able to limit access to the Office Space budget data cells from higher level users.

At optional step 708, the user reassigns access rights to at least a portion of the at least one highlighted data cell to another user. As provided above, John Brown has access to the entire Office Space budget (from the access rights given to him in FIG. 5). John Brown can reassign access rights to a portion of the Office Space budget to another user.

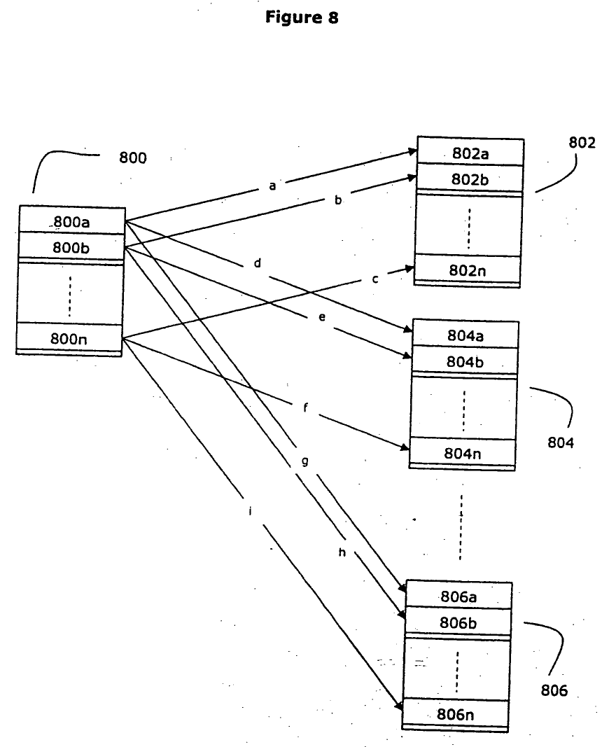

In the exemplary embodiments of the present invention described with reference to FIGS. 1-7, an e-mail address is entered (e.g., typed, copied/pasted, linked) into a linking cell to associate the corresponding section of the data structure (e.g., data cells in a spreadsheet) with the user; however, the present invention is not limited thereto. The e-mail addresses may be associated with the sections of the data structure by any of a number of methods. For example, the e-mail addresses may be linked (e.g., via software) from an external source to the data structure. For example, FIG. 8 illustrates source file 800. Source file 800 includes a listing of e-mail addresses including address 800a, address 800b, and address 800n. Software links the e-mail addresses from source file 800 to data structures 802, 804, and 806.

Data structure 802 (e.g., a spreadsheet) includes sections 802a, 802b, and 802n (e.g., groups of data cells in a spreadsheet). Likewise, data structure 804 includes sections 804a, 804b, and 804n, and data structure 806 includes sections 806a, 806b, and 806n. In the exemplary embodiment of the present invention illustrated in FIG. 8, e-mail address 800a is associated with section 802a (illustrated through arrow a), section 804a (illustrated through arrow d), and section 806a (illustrated through arrow g). Likewise, e-mail address 800b is associated with section 802b (illustrated through arrow b), section 804b (illustrated through arrow e), and section 806b (illustrated through arrow h), and e-mail address 800n is associated with section 802n (illustrated through arrow c), section 804n (illustrated through arrow f), and section 806n (illustrated through arrow i).

Thus, the user corresponding to e-mail address 800a has access rights with respect to sections 802a, 804a, and 806a of data structures 802, 804, and 806, respectively. Likewise, the user corresponding to e-mail address 800b has access rights with respect to sections 802b, 804b, and 806b of data structures 802, 804, and 806, respectively. Further, the user corresponding to e-mail address 800n has access rights with respect to sections 802n, 804n, and 806n of data structures 802, 804, and 806, respectively.

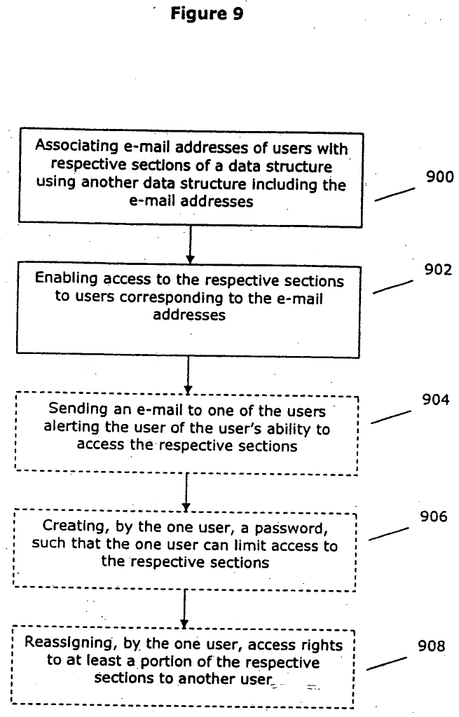

FIG. 9 is a flow diagram illustrating a method of enabling access to sections of a data structure. At step 900, e-mail addresses of users are associated with sections of a data structure using another data structure including the e-mail addresses. For example, in the exemplary embodiment of the present invention illustrated in FIG. 8, e-mail addresses from source file 800 are associated with sections of data structure 802. At step 902, access to the respective sections of the data structure is enabled to users of the corresponding e-mail addresses. Referring again to FIG. 8, access to section 802a of data structure 802 is enabled to the user of e-mail address 800a.

At optional step 904, an e-mail is sent to one of the users alerting the user of the user's ability to access the respective sections of the data structure. At optional step 906, the user creates a password such that the user can limit access to the respective sections of the data structure. At optional step 908, the user reassigns access rights to at least a portion of the respective sections of the data structure to another user.

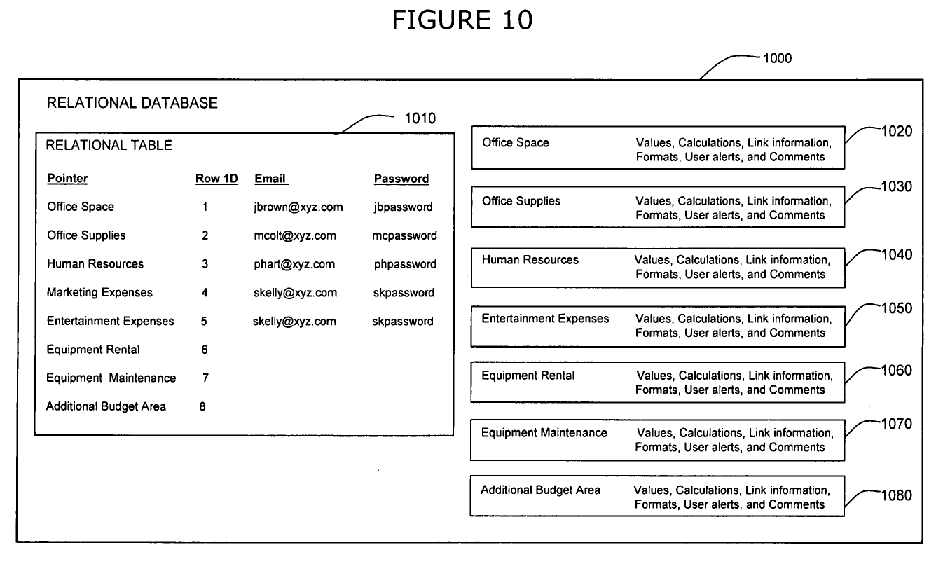

FIG. 10 is a block diagram illustrating a relational database 1000 in accordance with another embodiment of the present invention.

Referring to FIG. 10, the data structure illustrated in FIGS. 1-3 may be implemented by the relational database 1000 having a relational table 1010 with rows and columns. That is, the data structure may be visually represented to the users, for example, as a spreadsheet, as a word processing electronic document, or as a software based document (e.g., C program or HTML document), among others, however, the underlying data structure may be implemented as a relational database 1000 using a corresponding data model. The underlying data structure may include the relational table 1010, and one or more linked text fields 1020, 1030, 1040, 1050, 1060, 1070 and 1080. Each of the relational table 1010 and the linked text fields 1020, 1030, 1040, 1050, 1060, 1070 and 1080 may be provided in the relational database 1000 and may define the data structure such that, for example, the visualized spreadsheet presented to the users is scalable and may be simultaneously used (e.g., accessed, viewed, copied and/or edited) by any number of different users suitably provided access rights. This can be accomplished because the relational database 1000 ensures data integrity of all-relational data stored in the relational table 1010 regardless of the number of users simultaneously using the relational database 1000. That is, for example, the relational database 1000 may lock out a second user requesting information that is currently being updated by a first user until the first user is finished updating the information.

The relational table 1010 may store a first set of relational data, for example, one or more budget area pointers (e.g., an office space pointer, an office supplies pointer, a human resources pointer, a marketing expenses pointer, an entertainment expenses pointer, an equipment rental pointer and an equipment maintenance pointer) to the one or more linked text fields 1020, 1030, 1040, 1050, 1060, 1070 and 1080 and one or more E-mail addresses (e.g., jbrown@xyz.com, mcolt@xyz.com, phart@xyz.com and skelly@xyz.com) corresponding to the one or more budget area pointers for use in (e.g., accessing, editing, opening and/or viewing) the one or more linked text files 1020, 1030, 1040, 1050, 1060, 1070 and 1080.

As illustrated in FIG. 1, since, for example, e-mail addresses are not stored in the “Assigned E-mail” fields for Equipment Rental and Equipment Maintenance, the linked text fields 1060 and 1070 related to these budget area may be accessible to only a system administrator having access and assignment rights to the entire data structure.

The one or more linked text fields 1020, 1030, 1040, 1050, 1060, 1070 and 1080 may store a second set of relational data. An example of the second set of data may be values, calculation, algorithms, linking information and/or formats of data cells within the data structure, and/or user alerts or comments related to the data cells of the data structure.

Use of the one or more linked text fields 1020, 1030, 1040, 1050, 1060, 1070 and 1080 is enabled by a one-to-many relationship between respective relational data of the first set and respective relational data of the second set. The data model for the relational database 1000 is based on each element of relational data of the first set and the one or more linked text fields 1020, 1030, 1040, 1050, 1060, 1070 and 1080. That is, the data model for the relational database 1000 is transparent to (i.e., does not formally extend to) the relational data of the second set stored in the one or more linked text fields 1020, 1030, 1040, 1050, 1060, 1070 and 1080. Because of the one-to-many relationship between a respective element of relational data of the first set and a respective many elements of relational data of the second set, shared use (i.e., simultaneous use by a plurality of users) of the second set of relational data may be provided without extending the data model of the relational database 1000 to include each element of relational data of the second set.

The shared use of the second set of relational data, simultaneously, by the plurality of users may be implemented programmatically via the first set of relational data stored in the relational table 1010 of the relational database 1000. That is, by pre-defining a structure of each linked text field 1020, 1030, 1040, 1050, 1060, 1070 and 1080, for example, a comma separated value (CSV) text field, an extendable markup language (XML) text field or indexed text field, among others, an application program can programmatically extend row and column attributes of the relational table 1010 and may store these attributes in the one or more linked text fields 1020, 1030, 1040, 1050, 1060, 1070 and 1080 when the data structure is changed.

For example, if a new Budget Area, Research and Development, is added to the data structure as a new column (i.e., the additional budget area row with row id 8 is implemented as the Research and Development budget area in the relational database 1000), then the application program may update the respective linked text field 1080 to add relational data of the second set at appropriate locations.

Moreover, by providing the one or more linked text fields 1020, 1030, 1040, 1050, 1060, 1070 and 1080 and predefining the structure thereof, performance of the overall application can be optimized because each element of relational data of the second set stored in the one or more linked text fields 1020, 1030, 1040, 1050, 1060, 1070 and 1080 may alternatively be stored in the relational table 1010. Accordingly, the second set of relational data stored in the one or more linked text fields 1020, 1030, 1040, 1050, 1060, 1070 and 1080 may be interchangeably stored as one or more predefined columns in the relational table 1010, or stored as a plurality of-dynamically adjustable columns in the one or more text fields 1020, 1030, 1040, 1050, 1060, 1070 and 1080, or stored as a plurality of dynamically adjustable rows and columns in the one or more text fields 1020, 1030, 1040, 1050, 1060, 1070 and 1080, based on application requirements and without modifying the data model or substantially affecting the size of the relational database 1000. Thus, in such a configuration of the relational database 1000, the number of columns in the relational table 1010 may remain constant.

For each row of the relational table 1010, a respective column may define a pointer to a respective budget area text field 1020, 1030, 1040, 1050, 1060, 1070 and 1080 representing a budget area of the company (e.g., an Office Space budget, an Office Supplies budget, a Human Resources budget, a Marketing Expenses budget, an Entertainment Expenses budget, an Equipment Rental budget, and an Equipment Maintenance budget. Each of these budget area text fields, 1020, 1030, 1040, 1050, 1060, 1070, and 1080 may include, for example, values, calculations, algorithms, linking information and/or formats of data cells within the data structure, and/or user alerts or comments related to the data cells of the data structure.

For each row of the relational table 1010, another respective column may preferably define the “Assigned E-mail” value, for example, jbrown@xyz.com for the budget area related to Office Space (best shown in FIG. 1). The “Assigned E-mail” value, for example, jbrown@xyz.com, stored as relational data in the relational table 1010 may define access rights to corresponding relational data in the one or more linked text fields 1020, 1030, 1040, 1050, 1060, 1070 and 1080.

“Access rights” refer to one or more rights granted to a user related to using corresponding relational data in the one or more linked text fields 1020, 1030, 1040, 1050, 1060, 1070 and 1080 and may include any one or more of the following capabilities: access to the relational data in the one or more linked text fields 1020, 1030, 1040, 1050, 1060, 1070 and 1080; creating or viewing of relational data in the one or more linked text fields 1020, 1030, 1040, 1050, 1060, 1070 and 1080; copying of the relational data to/from the one or more linked text fields 1020, 1030, 1040, 1050, 1060, 1070 and 1080; and/or editing of the relational data in the one or more linked text fields 1020, 1030, 1040, 1050, 1060, 1070 and 1080.

For each row of the relational table 1010, another respective column may preferably define a password, for example, jbpassword corresponding to Jim Brown having the Assigned E-mail value, jbrown@xyz.com, for the budget area related to Office Space. The password linked to the “Assigned E-mail” value stored as relational data in the relational table 1010 may define access rights including the type of access, for example, creation access, edit access or view access to corresponding relational data in the one or more linked text fields 1020, 1030, 1040, 1050, 1060, 1070 and 1080.

That is, passwords may be preferably stored in the relational table 1010 for limiting access to corresponding portions of the one of more linked text fields 1020, 1030, 1040, 1050, 1060, 1070 and 1080 to provide protection against unauthorized use of the corresponding portions of the one of more linked text fields 1020, 1030, 1040, 1050, 1060, 1070 and 1080. A link between each password stored and a corresponding e-mail address of the respective assigned user may be established to limit access to the corresponding portion of the relational data based on a respective e-mail address and linked password. Moreover, different passwords linked to respective e-mail addresses may enable differentiation of access rights. For a respective e-mail address, plural password may be provided, such that, for example, a first password of the plural password may allow for only viewing of the corresponding portion of the relational data and a second password may allow editing access of the corresponding portion of the relational data. Other passwords may allow for other access right options such as creation access or system administrator access.

Alternatively, passwords may be stored in the one or more linked text fields 1020, 1030, 1040, 1050, 1060, 1070 and 1080. Details relating to the storage of the passwords in the one or more linked text fields 1020, 1030, 1040, 1050, 1060, 1070 and 1080 are provided later in a discussion of the one or more linked text fields 1020, 1030, 1040, 1050, 1060, 1070 and 1080.

An arrangement order of the relational data in the one or more linked text fields 1020, 1030, 1040, 1050, 1060, 1070 and 1080 may correspond to an arrangement order of cells of the visualized spreadsheet presented to the user, arranged in rows and columns for display by the application program.

It is contemplated that respective linked text fields 1020, 1030, 1040, 1050, 1060, 1070 and 1080 may have a common predefined structure or different predefined structures. The predefined structures may include one of, for example a file having fixed length fields, variable length fields with an index, comma separated values (CSV) or other character or space delimited fields, among other.

In the case of elements of relational data that have fixed length fields and that are stored in the one or more linked text fields 1020, 1030, 1040, 1050, 1060, 1070 and 1080, the absolute position of each element of data may be determined. After the absolute positions are determined, the relative positions (i.e. arrangement order) of the elements of relational data stored in the one or more linked text fields 1020, 1030, 1040, 1050, 1060, 1070 and 1080 may correspond to the relative positions (i.e., arrangement order) of cells of the visualized spreadsheet presented to the user, arranged in rows and columns for display by the application program.

In the case of elements of relational data separated by commas and stored in the one or more linked text fields 1020, 1030, 1040, 1050, 1060, 1070 and 1080, each element of relational data may have a variable length. In such a case, the relative position of each element of data may be determined based on positions of commas in the linked text fields 1020, 1030, 1040, 1050, 1060, 1070 and 1080. After the relative positions are determined, the relative positions (i.e. arrangement order) of the elements of relational data stored in the one or more linked text fields 1020, 1030, 1040, 1050, 1060, 1070 and 1080 may correspond to the relative positions (i.e., arrangement order) of cells of the visualized spreadsheet presented to the user, arranged in rows and columns for display by the application program.

The one or more linked text fields 1020, 1030, 1040, 1050, 1060, 1070 and 1080 preferably may be provided as extendable markup language (XML) files and/or comma separated value files.

Each XML file may be implemented with one or more nodes. For example, row values of data cells of the data structure may be stored in an XML linked file having only a single node and format types that are format characteristics of respective data cells of the data structure, which may include font styles, font sizes, font colors, the number of decimals of a row value shown, among other, may be stored in another XML linked file, each format type may be stored as a respective node of a plurality of nodes. Alternatively the row values of data cells and format types may be stored together in a plurality of nodes in one XML linked file.

Implementing the one or more linked text fields 1020, 1030, 1040, 1050, 1060, 1070 and 1080 with an index allows the application program to more quickly search the linked text field for the appropriate data of the second set by accessing directly certain indexed locations in the one or more linked text fields 1020, 1030, 1040, 1050, 1060, 1070 and 1080, thereby reducing search time.

A query of the relational database 1000 based on, for example, access rights from Sam Kelly (i.e., the user corresponding to the e-mail address skelly@xyz.com retrieves only selected linked text fields 1050 and 1060 corresponding to Sam Kelly's access rights. Programmatically, the data structure may then be accessed, viewed, edited etc. according to the second set of relational data from the selected linked text fields 1050 and 1060.

In this case, since the data in the selected linked text fields 1050 and 1060 is not part of the data model, the selected linked text fields 1050 and 1060 are retrieved and the relationship between the relational data of the second set stored in the selected linked text fields 1050 and 1060 is reconstructed programmatically based on the predefined structure of the selected linked text fields 1050 and 1060.

Passwords may be optionally stored in the one or more linked text fields 1020, 1030, 1040, 1050, 1060, 1070 and 1080 for limiting access to other corresponding portions of the one of more linked text fields 1020, 1030, 1040, 1050, 1060, 1070 and 1080 to provide protection against unauthorized use of the other corresponding portions of the one of more linked text fields 1020, 1030, 1040, 1050, 1060, 1070 and 1080. A link between each password stored and a corresponding e- mail address of the respective assigned user may be established to limit access to the corresponding portion of the relational data based on a respective e-mail address and linked password. Moreover, different passwords linked to respective e-mail addresses may enable differentiation of access rights. That is, for a respective e-mail address, plural password may be provided, such that, for example, a first password of the plural password may allow for only viewing of the corresponding portion of the relational data and a second password may allow editing access of the corresponding portion of the relational data. Other passwords may allow for other access right options such as creation access or system administrator access.

Although the relational database of FIG. 10 includes the relational table 1010 and seven linked text fields 1020, 1030, 1040, 1050, 1060, 1070 and 1080, it is contemplated that any number of relational tables and any number of linked text fields may be used, as long as each portion of the one or more linked text fields are provided access rights according to data stored in the one or more relational tables.

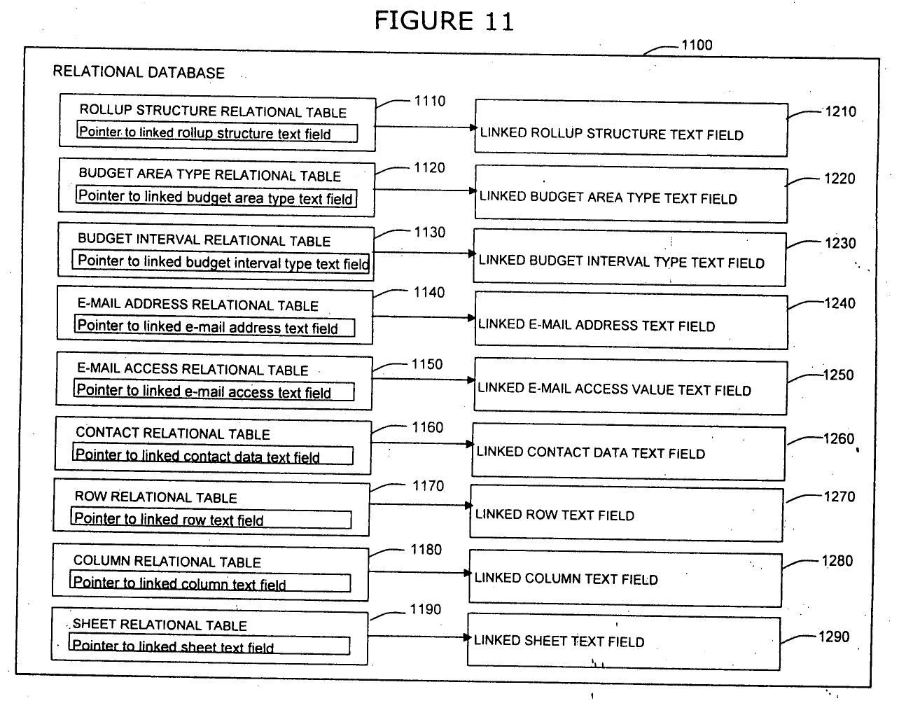

FIG. 11 is a block diagram illustrating another relational database 1100 in accordance with another embodiment of the present invention.

Referring to FIG. 11, a relational database 1100 having a plurality of relational tables 1110, 1120, 1130, 1140, 1150, 1160, 1170, 1180 and 1190 with rows and columns. That is, the data structure may be visually represented to the users, for example, as a spreadsheet, as a word processing electronic document, or as a software based document (e.g., C program, HTML document), among others, however, the underlying data structure may be implemented as a relational database 1100 using a corresponding data model. The underlying data structure may include the plurality of relational tables 1110, 1120, 1130, 1140, 1150, 1160, 1170, 1180 and 1190, and a plurality of linked text fields 1210, 1220, 1230, 1240, 1250, 1260, 1270, 1280 and 1290. Each of the relational tables 1110, 1120, 1130, 1140, 1150, 1160, 1170, 1180 and 1190 and the linked text fields 1210, 1220, 1230, 1240, 1250, 1260, 1270, 1280 and 1290 may be provided in the relational database 1100 and may define the data structure such that, for example, the visualized spreadsheet presented to the users is scalable and may be simultaneously used (e.g., created, accessed, viewed, copied and/or edited) by any number of different users suitably provided access rights. This can be accomplished because the relational database 1100 provides data integrity to ensure that all relational data stored in the plurality of relational tables 1110, 1120, 1130, 1140, 1150, 1160, 1170, 1180 and 1190 have data integrity regardless of the number of users simultaneously using the relational database 1100.

The plurality of relational tables 1110, 1120, 1130, 1140, 1150, 1160, 1170, 1180 and 1190 may each store first relational data, for example, a respective pointer (e.g., a pointer to a linked rollup structure text field 1210, a pointer to a linked budget area type text field 1220, a pointer to a linked budget interval type text field 1230, a pointer to a linked e-mail address text field 1240, a pointer to a linked e-mail access text field 1250, a pointer to a linked contact data text field 1260, a pointer to a linked row text field 1270, a pointer to a linked column text field 1280, and a pointer to a linked sheet text field 1290 for use in (e.g., creating, accessing, editing, opening and/or viewing) the plurality of linked text fields 1210, 1220, 1230, 1240, 1250, 1260, 1270, 1280 and 1290.

The plurality of linked text fields 1210, 1220, 1230, 1240, 1250, 1260, 1270, 1280 and 1290 may store second relational data. An example of the second relational data may be types values, calculation, algorithms, linking information and/or formats of data cells within the data structure, and/or user alerts or comments related to the data cells of the data structure.

Use of the plurality of linked text fields 1210, 1220, 1230, 1240, 1250, 1260, 1270, 1280 and 1290 is enabled by a one-to-many relationship between respective first relational data and respective second relational data. The data model for the relational database 1100 is based on each element of first relational data and each of the plurality of linked text fields 1210, 1220, 1230, 1240, 1250, 1260, 1270, 1280 and 1290. That is, the data model for the relational database 1100 is transparent to (i.e., does not formally extend to) the second relational data stored in the plurality of linked text fields 1210, 1220, 1230, 1240, 1250, 1260, 1270, 1280 and 1290. Shared use (i.e., simultaneous use by a plurality of users) of the second relational data may be provided without extending the data model of the relational database 1100 to include each element of second relational data.

The simultaneous use of the second relational data by the plurality of users may be implemented programmatically via the first relational data stored in the plurality of relational tables 1110, 1120, 1130, 1140, 1150, 1160, 1170, 1180 and 1190 of the relational database 1100. That is, by pre-defining a structure of each linked text field 1210, 1220, 1230, 1240, 1250, 1260, 1270, 1280 and 1290, for example, a comma separated value text field or an XML text field, among others, an application program can programmatically extend row and column attributes of the plurality of relational tables 1110, 1120, 1130, 1140, 1150, 1160, 1170, 1180 and 1190 and may store these attributes in the plurality of linked text filed 1210, 1220, 1230, 1240, 1250, 1260, 1270, 1280 and 1290 when the data structure is changed.

For example, if a new Budget Area, Research and Development, is added to the data structure as a new column of the data structure (i.e., the additional budget area type is implemented as the Research and Development budget area type in the linked budget area type text field 1220 of the relational database 1100), then the application program may update other respective linked text field 1210, 1230, 1240, 1250, 1260, 1270, 1280, 1290 to add second relational data at appropriate locations corresponding to the newly added Research and Development budget area type which provides for the new column of the data structure.

Moreover, by providing the plurality of linked text fields 1210, 1220, 1230, 1240, 1250, 1260, 1270, 1280 and 1290 and predefining the structure of the plurality of linked text fields 1210, 1220, 1230, 1240, 1250, 1260, 1270, 1280 and 1290, performance of the overall application can be optimized because each element of second relational data stored in the plurality of linked text fields 1210, 1220, 1230, 1240, 1250, 1260, 1270, 1280 and 1290 may alternatively be stored in a corresponding relational table 1110, 1120, 1130, 1140, 1150, 1160, 1170, 1180 and 1190, respectively. Accordingly, the second relational data stored in the one or more linked text fields 1210, 1220, 1230, 1240, 1250, 1260, 1270, 1280 and 1290 may be interchangeably stored as predefined one or more columns in the corresponding relational tables 1110, 1120, 1130, 1140, 1150, 1160, 1170, 1180 and 1190, or stored as a plurality of dynamically adjustable columns in the plurality of linked text fields 1210, 1220, 1230, 1240, 1250, 1260, 1270, 1280 and 1290, or stored as a plurality of dynamically adjustable rows and columns in the plurality of linked text fields 1210, 1220, 1230, 1240, 1250, 1260, 1270, 1280 and 1290, based on the application requirements and without modifying the data model or substantially affecting the size of the relational database 1100. Thus, in such a configuration of the relational database 1100, the number of columns in the plurality of relational tables 1110, 1120, 1130, 1140, 1150, 1160, 1170, 1180 and 1190 may remain constant.

For each relational table 1110, 1120, 1130, 1140, 1150, 1160, 1170, 1180 and 1190, a respective column may define a pointer to a respective linked text field 1210, 1220, 1230, 1240, 1250, 1260, 1270, 1280 and 1290 representing a portion of the second relational data.

More particularly, a rollup structure relational table 1110 may include the pointer to the linked rollup structure text field 1210, a budget area type relational table 1120 may include the pointer to the budget area type text field 1220, a budget interval relational table 1130 may include the pointer to the linked budget interval type text field 1230, an e-mail address relational table 1140 may include the pointer to the linked e-mail address text field 1240, an e-mail access relational table 1150 may the include the pointer to the linked e-mail access text field 1250, a contact relational table 1160 may include the pointer to the linked contact data text field 1260, a row relational table 1170 may include the pointer to the linked row text field 1270, a column relational table 1180, may include the pointer to the linked column text field 1280, and a sheet relational table 1190 may include the pointer to the linked sheet text field 1290.

Additional levels of budget reporting may be provided such that a plurality of budget area data structures are implements, for example representing different lines of business, and may roll-up to higher levels, for example, a budget view of all Human Resources across plural Human Resources budget areas. The relational database 1100 may allow such a structure by desirably including the rollup structure relational table 1110 to dynamically define budget rollups. This may be accomplished by preferably including the pointer in the rollup structure relational table 1110 to the linked rollup text field 1210 that includes a rollup structure used for accessing, viewing, changing and/or copying budget rollups. The budget rollups may be a composite budget for a responsible area, for example, a corporation having multiple lines of business with similar budget areas. That is, the rollup structure may be desirably provided in the linked rollup text field 1210 so that limitations of data in the plurality of relational tables 1110, 1120, 1130, 1140, 1150, 1160, 1170, 1180 and 1190 related to predefining the budget rollups may be eliminated. That is, a maximum number of the budget rollups need not to be predefined in the relational database 1100 and, furthermore, each data item representing a budget rollup relationship need not be limited in size (due to the maximum size of each row in the relational database 1100 being limited in size, for example, to less than or equal to 8000 bytes if stored as a row in the rollup structure relational table 1110.

In this configuration, the rollup structure may be dynamically changed programmatically without redefining the relational database model and without substantially impacting the number of relational links in the relational database 1100.

It is contemplated that budget area types may be added, deleted or changed. The relational database 1100 allows for such additions, deletions or changes by desirably including a budget area type relational table 1120 to dynamically define budget areas for the budget process. This is accomplished by preferably including the pointer in the budget area type relational table 1120 to the linked budget area type text field 1220 having the budget area types which define the budget areas of a respective company (e.g., the Office Space budget, the Office Supplies budget, the Human Resources budget, the Marketing Expenses budget, the Entertainment Expenses budget, the Equipment Rental budget, and the Equipment Maintenance budget). That is, the budget area types may be desirably provided in the linked budget area type text field 1220 so that limitations of the data in the budget area type relational table 1120 of the relational database 1100 may be eliminated.

In this configuration, the budget area structure may be dynamically changed programmatically without redefining the relational database model and without substantially impacting the number of relational links in the relational database 1100. For example, a maximum number of the budget area types need not to be predefined in the relational database 1100 and, moreover, each budget area type need not be limited in size (i.e., byte size) as compared to directly storing the budget area types in the budget area type relational table 1120.

It is contemplated that budget reporting intervals may start at any timeframe and proceed according to any budget reporting interval. For example, budget reporting intervals may be established to be bimonthly, to span a different period than a calendar year, for example, a two year period or start and/or end in different months corresponding to, for example, a fiscal year, other than the calendar year.

The relational database 1100 may allow for such starting timeframe and budget reporting intervals by desirably including a budget interval relational table 1130. This is accomplished by preferably including the pointer in the budget interval relational table 1130 to the linked budget interval type text field 1230 having budget interval types which define the budget reporting intervals, for example, monthly from January through December of the current year. That is, the budget interval types may be desirably provided in the linked budget interval text field 1230 so that limitations of the data in the budget interval relational table 1130 of the relational database 1100 may be eliminated.

In this configuration, the budget reporting interval structure may be dynamically changed programmatically without redefining the relational database model and without substantially impacting the number of relational links in the relational database 1100. For example, a maximum number of the budget reporting intervals need not to be predefined in the relational database 1100 and, furthermore, each budget interval type need not be limited in size (i.e., byte size) as compared to directly storing the budget interval types in the budget interval relational table 1130.

The relational database 1100 may include an e-mail address relational table 1140 which preferably may include the pointer to the linked e-mail address text field 1240 having e-mail addresses stored therein which a user may maintain or, otherwise, which may be selectable for the Assigned E-mail fields of the data structure by a respective user to assign access rights. These e-mail addresses may be selected according to menus at the Assigned E-mail fields, for example, by a scroll down menu, or by text entry, among others to limit the entry into the Assigned E-mail to predefined e-mail addresses stored in the e-mail address text field 1240.

In this configuration, the number of e-mail addresses may be dynamically changed programmatically without redefining the relational database model and without substantially impacting the number of relational links in the relational database 1100 so that limitations of the data in the e-mail address relational table 1140 of the relational database 1100 may be eliminated. For example, a maximum number of the email addresses need not to be predefined in the relational database 1100 and, furthermore, each e-mail address need not be limited in size (i.e., byte size) as compared to directly storing the e-mail address in the e-mail address relational table 1140.

It is contemplated that e-mail addresses may be established for only particular users or may be generally restricted to e-mail addresses having a specific character string in the e-mail address (e.g., an ending portion, such as @xyz.com).

It is further contemplated that initially, assignment of access rights may only be provided by a system administrator having access and assignment rights to the entire data structure. Once an assignment of the access rights is made by the system administrator or an assignee of the system administrator, further assignments may be made by those having access rights to any portion of those access rights according to, for example, e-mail addresses stored in “Assigned E-mail” fields (see, for example, FIG. 1).

It is contemplated that the relational database 1100 may include the e-mail access relational table 1150 to enable access rights to portions of the respective linked text fields 1210, 1220, 1230, 1240, 1250, 1260, 1270, 1280 and 1290. The respective e-mail access values may be preferably selected from among the e-mail addresses in the e-mail address text field 1240 according to the menus at the Assigned E-mail fields or, otherwise, be entered by any user having suitable access rights. “Access rights” refer to one or more rights granted to a user related to using corresponding relational data in the plurality of linked text fields 1210, 1220, 1230, 1240, 1250, 1260, 1270, 1280 and 1290 and may include any one or more of the following capabilities: access to the relational data stored in the plurality of linked text fields 1210, 1220, 1230, 1240, 1250, 1260, 1270, 1280 and 1290, creating or viewing of the relational data in the plurality of linked text fields 1210, 1220, 1230, 1240, 1250, 1260, 1270, 1280 and 1.290, copying of the relational data to/from the plurality of linked text fields 1210, 1220, 1230, 1240, 1250, 1260, 1270, 1280 and 1290 and/or editing of the relational data stored in the plurality of linked text fields 1210, 1220, 1230, 1240, 1250, 1260, 1270, 1280 and 1290.

The e-mail access values may preferably define which values of the data structure are accessible to a particular user. That is, the e-mail access value text field 1250 may include one or more pointers/locators to particular portions of the respective linked text fields 1210, 1220, 1230, 1240, 1260, 1270, 1280 and 1290 that a particular user can access (i.e., the particular user has access right thereto). That is, the e-mail access value text field 1250 may maintain a link between the assigned e-mail address and locations of the second relational data in the linked text fields 1210, 1220, 1230, 1240, 1260, 1270, 1280 and 1290 to ensure security of the second relational data.

The linked e-mail access value text field 1250 may include, for example, the e-mail addresses of respective users that are granted access to at least a portion of the data structure. That is, respective users that are authorized and are assigned access rights to at least a portion of the data structure based on corresponding e-mail addresses, for example, provided in the “Assigned E-mail” data cells of the data structure.

It is contemplated that the relational database 1100 may include the contact relational table 1160, and be linked by the pointer to the linked contact data text field 1260, which may include, for example, the e-mail addresses of at least all users maintained in the linked e-mail address text field 1140 and may further include one or more telephone numbers of those users, one or more cell phone numbers of those users and/or one or more business locations of those users, among others. Contact data types and values in the linked contact text field 1260 may be entered by users having suitable access rights or, otherwise, may be downloaded from company-wide contact directories maintained in separate applications using a standard protocol.

In this configuration, the contact types and values may be dynamically changed programmatically without redefining the relational database model. For example, a maximum number of contact data types and values need not to be predefined in the relational database and, furthermore, each contact data type and/or value need not be limited in size (i.e., byte size) as compared to directly storing the contact data type and/or value in the contact relational table 1160.

An arrangement order of the relational data in the plurality of linked text fields 1210, 1220, 1230, 1240, 1250, 1260, 1270, 1280 and 1290 may correspond to an arrangement order of cells of the visualized spreadsheet presented to the user, arranged in rows and columns for display by the application program.

It is contemplated that respective linked text fields 1210, 1220, 1230, 1240, 1250, 1260, 1270, 1280 and 1290 may have a common predefined structure or different predefined structures. The predefined structure may include one of, for example, a file having fixed length fields, variable length fields with an index or comma separated values (CSV), among other.

In the case of elements of relational data that have fixed length fields and that are stored in the plurality of linked text fields 1210, 1220, 1230, 1240, 1250, 1260, 1270, 1280 and 1290, the absolute position of each element of data may be determined. After the absolute positions are determined, the relative positions (i.e., arrangement order) of the elements of relational data stored in the plurality of linked text fields 1210, 1220, 1230, 1240, 1250, 1260, 1270, 1280 and 1290 may correspond to the relative positions (i.e., arrangement order) of cells, arranged in rows and columns for display by the application program.

In the case of elements of relational data separated by commas (i.e., comma delimited) and stored in the one or more linked text fields, 1210, 1220, 1230, 1240, 1250, 1260, 1270, 1280 and 1290, each element of relational data may have a variable length. In such a case, the relative positions of each of the elements of data may be determined based on positions of commas in the linked text fields 1210, 1220, 1230, 1240, 1250, 1260, 1270, 1280, and 1290. After the relative positions are determined, the relative positions (i.e. arrangement order) of the elements of relational data stored in the one or more linked text fields may correspond to the relative positions (i.e., arrangement order) of cells of the visualized spreadsheet presented to the user, arranged in rows and columns for display by the application program.

The plurality of linked text fields 1210, 1220, 1230, 1240, 1250, 1260, 1270, 1280 and 1290 preferably may be provided as extendable markup language (XML) files and/or comma separated value files.

Each XML file may be implemented with one or more nodes. For example, row values of data cells of the data structure may be stored in an XML linked file at one node and format types that are format characteristics of respective data cells of the data structure, which may include font styles, font sizes, font colors, the number of decimals of a row value shown, among other, may be stored in the same XML linked file as one or more other nodes. Alternatively the format type may be stored in a different XML linked file as one or more nodes of the different XML linked file.

A query of the relational database 1100 based on, for example, access rights from Sam Kelly (e.g., a user corresponding to the e-mail address skelly@xyz.com may retrieve respective linked text fields 1210, 1220, 1230, 1240, 1250, 1260, 1270, 1280 and 1290 corresponding to Sam Kelly's access rights, Programmatically, the data structure may then be accessed, viewed, edited etc. according to the access rights provided according to the e-mail addresses and pointer/locator values of the linked e-mail access text field 1250.

Although the e-mail accesses text field 1250 is illustrated, it is contemplated that all of the e-mail addresses and locator values provided therein may be to provided in the e-mail address relational table 1150 as first relational data to reduce the amount of data manipulation needed to maintain the data integrity of the linked text fields 1210, 1220, 1230, 1240, 1250, 1260, 1270, 1280 and 1290.

Passwords may be stored in, for example the linked e-mail access text field 1250 for limiting access to other corresponding portions of the plurality of linked text fields 1210, 1220, 1230, 1240, 1260, 1270, 1280 and 1290 to provide protection against unauthorized use of other corresponding portions of the plurality of linked text fields 1210, 1220, 1230, 1240, 1260, 1270, 1280 and 1290. A link between each password stored and a corresponding e-mail address of the respective assigned user may be established to limiting access to the corresponding portion of the second relational data based on a respective e-mail address and linked password.

For a respective e-mail address, plural passwords may be provided such that, for example, a first password of the plural password may allow for only viewing of the corresponding portion of the second relational data and a second password may allow editing access of the corresponding portion of the second relational data. Other passwords may allow for other access options such as creation access or system administrator access.

It is contemplated that the relational database 1100 may include the row relational table 1170 linked by the pointer to the linked row text field 1270. The linked row text field 1270 may store, for example, second relational data such as values, calculation, algorithms, linking information and/or formats of data cells within the data structure, and/or user alerts or comments related to the data cells of the data structure. That is, row types and values may be desirably provided in the linked row text field 1270 so that limitations of the data in the row relational table 1170 of the relational database 1100 may be eliminated.

In this configuration, the row types and values may be dynamically changed programmatically without redefining the relational database model and without substantially impacting the number of relational links in the relational database 1100. For example, a maximum number of the row type and/or values need not to be predefined in the relational database 1100 and, furthermore, each row type and/or value need not be limited in size (i.e., byte size) as compared to directly storing the row type and/or values in the row relational table 1170.

It is contemplated that the relational database 1100 may include the column relational table 1180 linked by the pointer to the linked column text field 1280. The linked column text field 1280 may store, for example, second relational data such as values, calculation, algorithms, linking information and/or formats of data cells within the data structure, and/or user alerts or comments related to the data cells of the data structure. That is, column types and values may be desirably provided in the linked column text field 1280 so that limitations of the data in the column relational table 1180 of the relational database 1100 may be eliminated.

In this configuration, the column types and values may be dynamically changed programmatically without redefining the relational database model and without substantially impacting the number of relational links in the relational database 1100. For example, a maximum number of the column type and/or values need not to be predefined in the relational database 1100 and, furthermore, each column type and/or value need not be limited in size (i.e., byte size) as compared to directly storing the column type and/or values in the column relational table 1180.

It is contemplated that the relational database 1100 may include the sheet relational table 1190 linked by the pointer to the linked sheet text field 1290. The linked sheet text field 1290 may store, for example, second relational data such as values, calculation, algorithms, linking information and/or formats of data cells within the data structure, and/or user alerts or comments related to the data cells of the data structure. That is, sheet types and values may be desirably provided in the linked sheet text field 1290 so that limitations of the data in the sheet relational table 1190 of the relational database 1100 may be eliminated.

In this configuration, the sheet types and values may be dynamically changed programmatically without redefining the relational database model and without substantially impacting the number of relational links in the relational database 1100. For example, a maximum number of the sheet type and/or values need not to be predefined in the relational database 1100 and, furthermore, each sheet type and/or value need not be limited in size (i.e., byte size) as compared to directly storing the sheet type and/or values in the sheet relational table 1190.

Although the relational database of FIG. 11 includes a plurality of relational table 1110, 1120, 1130, 1140, 1150, 1160, 1170, 1180 and 1190 and a plurality of linked text fields 1210, 1220, 1230, 1240, 1250, 1260, 1270, 1280 and 1290, it is contemplated that any number of relational tables and any number of linked text fields may be used, as long as each portion of the linked text fields are provided access rights according to first data stored in the plurality of relational tables.

It is contemplated that the relational database 1100 may further store in the linked budget area type text field 1220, status and/or work flow data regarding the work flow of each budget type in the linked budget area type text field 1220. For example, the Office Space budget area which may be facilitated by John Brown (i.e., the user corresponding to the e-mail address jbrown@xyz.com) may have a pending status which is an open status, a released status, a completed status, an approved status, or an on hold status, among others.

By implementing the underlying structure of the data structure as the relational databases 1000 and 1100, speed of exchange of information among users can be increased, personnel time can be reduced, data accuracy can be improved, and data security can be assured. Moreover, the relational database 1100 is fully and completely scalable without modifying the database model thereof.

Various aspects of the present invention may be accomplished via the Internet. For example, the e-mail addresses of the users can be associated with sections of a data structure via the Internet. Further, the users can access their respective sections of the data structure via the Internet. Further still, the user can set up a password to limit access to the respective sections of the data structure via the Internet.

Although in certain environments it is desirable to conduct certain aspects of the present invention via the Internet, the present invention is not limited thereto. For example, such aspects can be conducted via other means such as a LAN, a WAN, an Intranet, etc.

Although the present invention has been described in terms of a method of enabling access rights to sections of a data structure, it is contemplated that the invention could be implemented entirely (or in part) through software on a computer readable carrier such as a magnetic or optical storage medium, or an auto frequency carrier or a radio frequency carrier.

Although the invention is illustrated and described herein with reference to specific embodiments, the invention is not intended to be limited to the details shown. Rather, various modifications may be made in the details within the scope and range of equivalents of the claims and without departing from the invention.

1. A relational database structured according to a relational data model for access by users from an application program being executed on a data processing system, comprising:
a relational table including at least a first set of relational data stored therein; and
at least one linked text field having a second set of relational data stored therein, the relational data of the first set stored in the relational table being in a one-to-many correspondence with relational data of the second set stored in the at least one linked text field.

2. The relational database according to claim 1, wherein the relational data of the first set stored in the relational table defines access rights to corresponding ones of the relational data of the second set stored in the at least one linked text field.

3. The relational database according to claim 1, wherein positions of the data in the at least one linked text field correspond to cells, arranged in rows and columns for display by the application program.

4. The relational database according to claim 1, wherein the at least one linked text field is a plurality of linked text fields and each of the plurality of linked text fields includes a data set, such that positions of the data in a respective data set correspond to cells, arranged in rows and columns for display by the application program.

5. The relational database according to claim 4, wherein a respective data set of the plurality of linked text fields includes one of values, calculation algorithms, link information, user alerts and comments, each of the values, calculation algorithms, link information, user alerts and comments of the respective data set having a correspondence to a respective one of the cells.

6. The relational database according to claim 2, wherein the relational database is simultaneously accessed by respective users according to respective relational data of the first set stored in the relational table.

7. The relational database according to claim 2 wherein the relational data of the first set stored in the relational table defines at least one of access to, creation of, viewing of, copying of or editing of corresponding ones of the relational data of the second set stored in the at least one linked text field.

8. The relational database according to claim 1, wherein the at least one linked text field is one of an extendable markup language file or a comma separated value file.

9. The relational database according to claim 1, wherein the at least one linked text field including a linked rollup structure text field to provide a budget rollup structure to dynamically define budget rollup groups.

10. The relational database according to claim 1, wherein the at least one linked text field including a linked budget interval text field to dynamically define a start timeframe and a budget reporting interval.

11. A relational database structured according to a relational data model for access by users from an application program being executed on a data processing system, comprising:
a relational table having plural e-mail addresses and at least one pointer stored therein; and
at least one text field linked by the at least one pointer, and having a data set of relational data stored therein, simultaneous access to portions of the data set in the linked text fields being enabled based on corresponding e-mail addresses of respective users stored in the relational table.

12. A method of storing and accessing data from a relational database according to a relational data model by an application program executed on a data processing system, the method comprising:
storing at least one first set of relational data in a relational table;
storing at least one linked text field having a second set of relational data such that the relational data of the first set stored in the relational table is in a one-to-many correspondence with the relational data of the second set stored in the at least one linked text field; and
accessing relational data of the second set stored in the at least one linked text field according to the respective one-to-many correspondence of the relational data of the at least one first set with the relational data of the second set stored in the at least one linked text field.

13. The method of claim 12, wherein the storing of the at least one first set of relational data in the relational table comprises:
entering e-mail addresses of respective users in the relational table to assign access rights to respective assigned users to respective portions of the second set of relational data; and
establishing a link between each e-mail address entered and a corresponding portion of the relational data of the second set.

14. The method of claim 12, wherein the storing of the second set of relational data in the relational table comprises:
storing passwords for limiting access to corresponding portions of the relational data of the second set in the relational table;
establishing a link between each password stored and a corresponding e-mail address of the respective assigned user; and
providing access to a portion of the relational data of the second set based on a respective linked e-mail address and password corresponding to the respective assigned user.

15. The method of claim 14, wherein the storing of passwords for providing access to portions of the relational data of the second set stored in the relational table includes storing a plurality of passwords for each corresponding e-mail address of the respective assigned user such that access rights are assignable to the respective assigned user according to the respective password provided by the respective assigned user.

16. The method of claim 15, wherein the plurality of passwords includes a first password for view access to the portion of the at least one text field, a second password for edit access to the portion of the at least one text field and a third password for creation access to the portion of the at least one text field.

17. The method of claim 12, wherein the storing of the second set of relational data in the relational table comprises:
storing passwords for limiting access to corresponding portions of the relational data of the second set in the at least one linked text field;
establishing a link between each password stored and a corresponding e-mail address of the respective assigned user; and
providing access to a portion of the relational data of the second set based on a respective linked e-mail address and password corresponding to the respective assigned user.

18. The method of claim 17, wherein the storing of passwords for providing access to portions of the relational data of the second set stored in the at least one linked text field includes storing a plurality of passwords for each corresponding e-mail address of the respective assigned user such that access rights are assignable to the respective assigned user according to the respective password provided by the respective assigned user.

19. The method of claim 18, wherein the plurality of passwords includes a first password for view access to the portion of the at least one text field, a second password for edit access to the portion of the at least one text field and a third password for creation access to the portion of the at least one text field.

20. The method of claim 13, wherein the entering of e-mail addresses of the respective users in the relational table to assign access rights includes:
reassigning all or a part of the access rights to respective portions of the second set of relational data assigned to one or more respective assigned users to reassigned users; and
when the access rights are reassigned, providing access to the portion of the relational data of the second set to one or both of the respective assigned user and/or the respective reassigned users based on respective e-mail addresses of the respective assigned user and/or the respective reassigned users entered in the relational table.
